(19) United States
(12) Patent Application Publication
(10) Pub. No.: US 2006/0218165 A1
(43) Pub. Date: Sep. 28, 2006

(54) Explicit overlay integration rules

(76) Inventors: Jeffrey de Vries, Sunnyvale, CA (US); Ann Hubbell, Los Altos Hills, CA (US)

Correspondence Address: PERKINS COIE LLP, P.O. BOX 2168, MENLO PARK, CA, 94026, US

(21) Appl. No.: 11/371,627

(22) Filed: Mar. 8, 2006

Related U.S. Application Data
(60) Provisional application No. 60/664,820, filed on Mar. 23, 2005.

(51) Int. Cl. G06F 7/00

(52) U.S. Cl. 707/100

(57) ABSTRACT

A technique for controlling access to files or directories in a system that includes and overlay involves the use of explicit overlay integration rules. An example of a method according to the technique may include providing an overlay to a file system structure; providing an explicit overlay integration rule; and directing a file access for a file that resides in the file system structure and in the overlay to either the file system structure or the overlay depending upon the explicit overlay integration rule. The overlay may or may not be associated with a streaming software program. The proposed system can offer, among other advantages more control over access to files and directories in the file system/overlay.

### BACKGROUND

Existing file systems with files and directories may have overlays. Overlays may be used in streaming software applications where the system is “tricked” into believing that the streamed software actually exists on the file system, when it actually exists “virtually” in the overlay. A description of streaming software is provided with reference to U.S. Pat. No. 6,453,334 filed on Jun. 16, 1998, which is incorporated herein by reference.

In cases where the directories of the overlay and the file system do not overlap, the system does not have difficulty determining which directory to access or which file to use. The system simply accesses a directory or file in the file system or in the overlay, depending upon where the directory or file resides. When accessing a directory or file in the overlay, the file or system may reside in a local cache, or must be downloaded before access is possible. In some other respects, the access to the file or directory of the overlay is similar to that of access to the file or directory of the file system.

In cases where the overlay and the file system overlap, however, systems simply access the directory or file in the overlay. The access is not by any explicit rule mechanism. Rather, the overlay is simply treated as a layer on top of the file system through which the system reaches in order to access files. Thus, if the system reaches through the overlay and comes across the file or >directory that it wants while in the overlay, then the system treats the found directory or file as the desired directory or file.

### SUMMARY

The following embodiments and aspects thereof are described and illustrated in conjunction with systems, tools, and methods that are meant to be exemplary and illustrative, not limiting in scope. In various embodiments, one or more of the above-described problems have been reduced or eliminated, while other embodiments are directed to other improvements.

A technique for controlling access to files or directories in a system that includes and overlay involves the use of explicit overlay integration rules. An example of a method according to the technique may include providing an overlay to a file system structure; providing an explicit overlay integration rule; and directing a file access for a file that resides in the file system structure and in the overlay to either the file system structure or the overlay depending upon the explicit overlay integration rule. The overlay may or may not be associated with a streaming software program. A file or directory in the overlay may be identical to or different from a file or directory in the filesystem structure with the same name.

Another example of a method according to the technique may include receiving an access request for a file; consulting explicit overlay integration rules; accessing the file in an overlay if an explicit overlay integration rule indicates the overlay has precedence over a file system structure; accessing the file in the file system structure if the explicit overlay integration rule indicates the file system structure has precedence over the overlay; and accessing the file according to file characteristics if the overlay integration rule indicates the overlay and the file system structure have equivalent precedence.

A system according to the technique may include a means for providing an overlay to a file system structure; a means for providing an explicit overlay integration rule; and a means for directing a file access for a file that resides in the file system structure and in the overlay to either the file system structure or the overlay depending upon the explicit overlay integration rule.

The proposed system can offer, among other advantages more control over access to files and directories in the file system/overlay. These and other advantages of the present invention will become apparent to those skilled in the art upon a reading of the following descriptions and a study of the several figures of the drawings.

### BRIEF DESCRIPTION OF THE DRAWINGS

FIG. 1 depicts a conceptual view of directories and an explicit rule set.

FIG. 2 depicts a conceptual view of files and an explicit rule set.

FIG. 3 depicts a flowchart of an example of a method for using explicit overlay integration rules.

FIG. 4 depicts a flowchart of an example of a method for file access.

FIG. 5 depicts a flowchart of an example of a method for obtaining an explicit overlay integration rule.

FIG. 6 depicts a flowchart of an example of a method for using explicit overlay integration rules at a streaming client.

FIG. 7 depicts a networked system for use in an embodiment.

FIG. 8 depicts a computer system for use in the system of FIG. 7.

### DETAILED DESCRIPTION

One technique for streaming software is described in the co-pending patent application Ser. No. 10/988,014 filed Nov. 11, 2004, entitled “SYSTEM AND METHOD FOR PREDICTIVE STREAMING”, which is incorporated herein by reference.

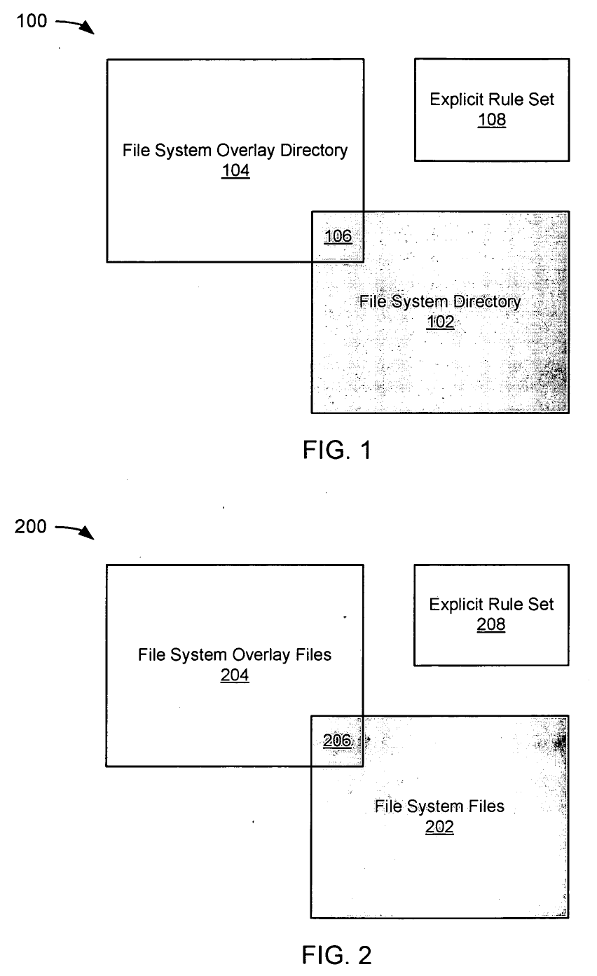

FIG. 1 depicts a conceptual view 100 of directories and an explicit rule set according to an embodiment. The view 100 includes a file system directory 102, an overlay directory 104, an overlap 106, and an explicit rule set 108. The explicit rule set 108 may include an explicit rule that the overlay directory 104 has precedence over the file system directory 102. In this case, if a directory is represented in both the file system directory 102 and the overlay directory 104 at the overlap 106, then the explicit rule forces access of a directory from the overlay directory 104. It may be noted that a system without the explicit rule set 108 may have a similar effect, but not rely upon explicit rules. In other words, prior art overlay directories that are the same as directories on the file system would effectively cover and conceal the file system directory.

Another explicit rule according to an aspect of an embodiment includes giving precedence to the file system over the overlay. The purpose of such a rule may be to give precedence to, by way of example but not limitation, local libraries so you have to stream less.

Another explicit rule according to an aspect of an embodiment includes merging the overlay directory and the file system directory. This rule may include exceptions and precedence rules based upon the directories themselves. For example, it may be desirable to access file system directories associated with Adobe Reader instead of the overlay directories. In this example, the Adobe Reader directories need not be streamed if the directories exist locally. In this way, the explicit rule may ensure that the local Adobe Reader directories are accessed in lieu of downloading.

FIG. 2 depicts a conceptual view 200 of files and an explicit rule set according to an embodiment. The view 200 includes file system files 202, overlay files 204, an overlap 206, and an explicit rule set 208. Rules for files are analogous to those of directories in some ways. However, files may have more characteristics from which to develop rules. Explicit rules for files may include by way of example but not limitation giving precedence to the file system or overlay depending upon the most recent file date or the most recent version of a file. The number of possible rules that may be derived for files is as varied as the files themselves. Some of the more obvious rules would refer to file details, such as file size, author, file type, etc.

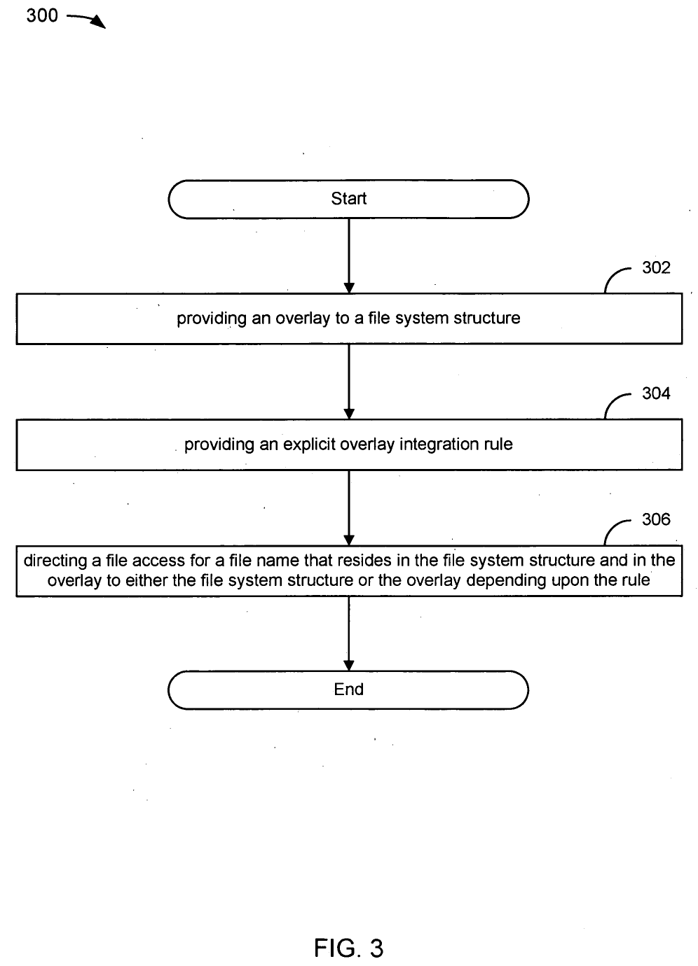

FIG. 3 depicts a flowchart 300 of an example of a method for using explicit overlay integration rules. The flowchart 300 starts at block 302 wherein an overlay to a file system structure is provided. The overlay may be associated with a streaming software procedure. Alternatively, for streaming media that makes use of an overlay, the overlay may be associated with a streaming media procedure.

In the example of FIG. 3, the flowchart 300 continues at block 304 wherein an explicit overlay integration rule is provided. The explicit overlay integration rule may be stored in memory and updated or changed by a user or an automated program.

In the example of FIG. 3, the flowchart 300 ends at block 306 wherein a file access for a file name that resides in the file system structure and in the overlay is directed to either the file system structure or the overlay depending upon the rule. If the explicit overlay integration rule indicates that file the file system structure takes precedence, then the file access is to a file in the file system structure. If the explicit overlay integration rule indicates that the overlay takes precedence, then the file access is to a file represented in the overlay. If the explicit overlay integration rule indicates that the file system and overlay are merged, then the rule should provide some logic for deciding whether to access the file in the file system structure or the file represented in the overlay such as, by way of example but not limitation, the version number of the file.

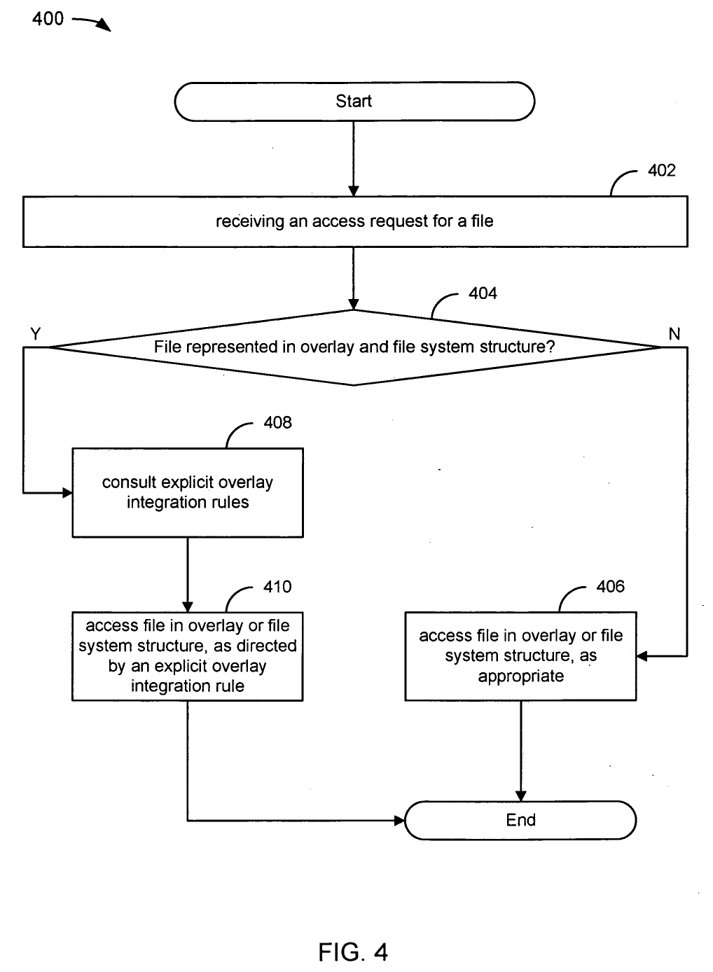

FIG. 4 depicts a flowchart 400 of an example of a method for file access. For illustrative purposes, the flowchart 400 ends after the file has been accessed. The flowchart 400 starts at block 402 wherein an access request is received for a file.

In the example of FIG. 4, the flowchart 400 continues at decision point 404 wherein it is determined whether the file is represented in an overlay and in the file system structure. A file may be represented in an overlay if the file is part of a streamed program.

If the file is not represented in both the overlay and in the file system structure (404-N), then the flowchart 400 continues at block 406 wherein the file is accessed in the overlay or in the file system structure, as appropriate. For example, if the file resides in the overlay, then the file is accessed in the overlay, but if the file resides in the file system structure, then the file is accessed in the file system structure. Then the flowchart 300 ends.

If, on the other hand, the file is represented in both the overlay and in the file system structure (404-Y), then the flowchart 400 continues at block 408 wherein the explicit overlay integration rules are consulted. The flowchart 400 then continues at block 410 wherein the file is accessed in the overlay or the file system structure, as directed by an explicit overlay integration rule. For example, if the explicit overlay integration rule indicates the overlay has precedence, the file is accessed in the overlay. After block 410, the flowchart 400 ends.

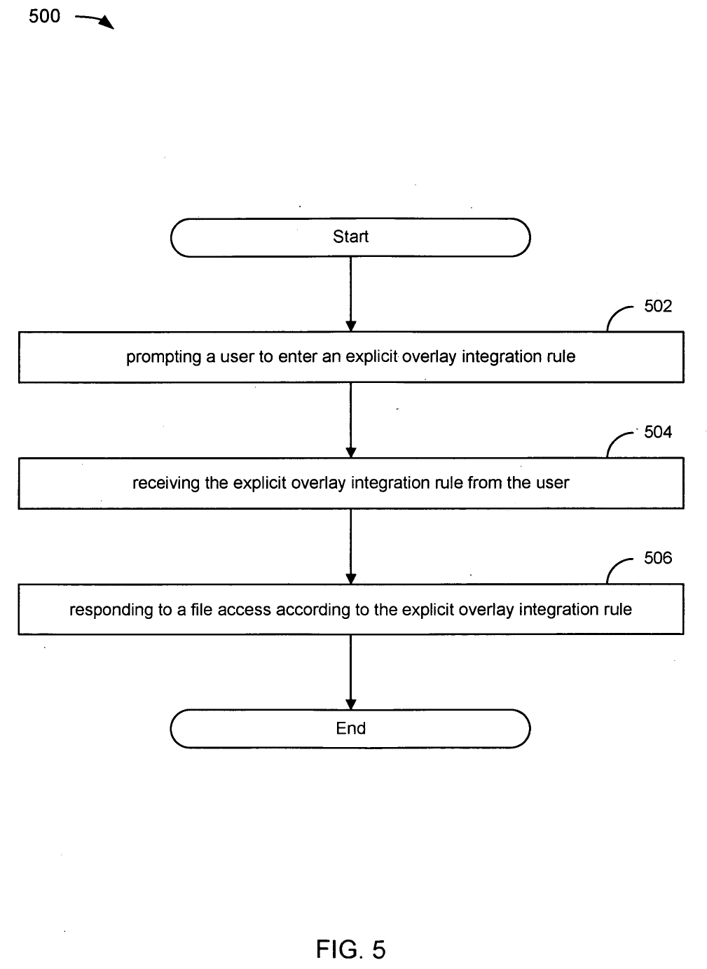

FIG. 5 depicts a flowchart 500 of an example of a method for obtaining an explicit overlay integration rule. The flowchart 500 begins at block 502 wherein a user is prompted to provide overlay integration behavior. For example, the user may be given the option of checking a checkbox that, by way of example but not limitation, allows files from a streamed application to be merged into a local directory.

In an embodiment, the flowchart 500 continues at block 504 with receiving the explicit overlay integration rule from the user. For example, if the user checks the checkbox then the system may merge the files and/or directories of the overlay into the file system structure. If the checkbox is not checked, then the system may give precedence to the overlay.

In an embodiment, the flowchart 500 continues at block 506 with responding to a file access according to the explicit overlay integration rule. Then the flowchart 500 ends.

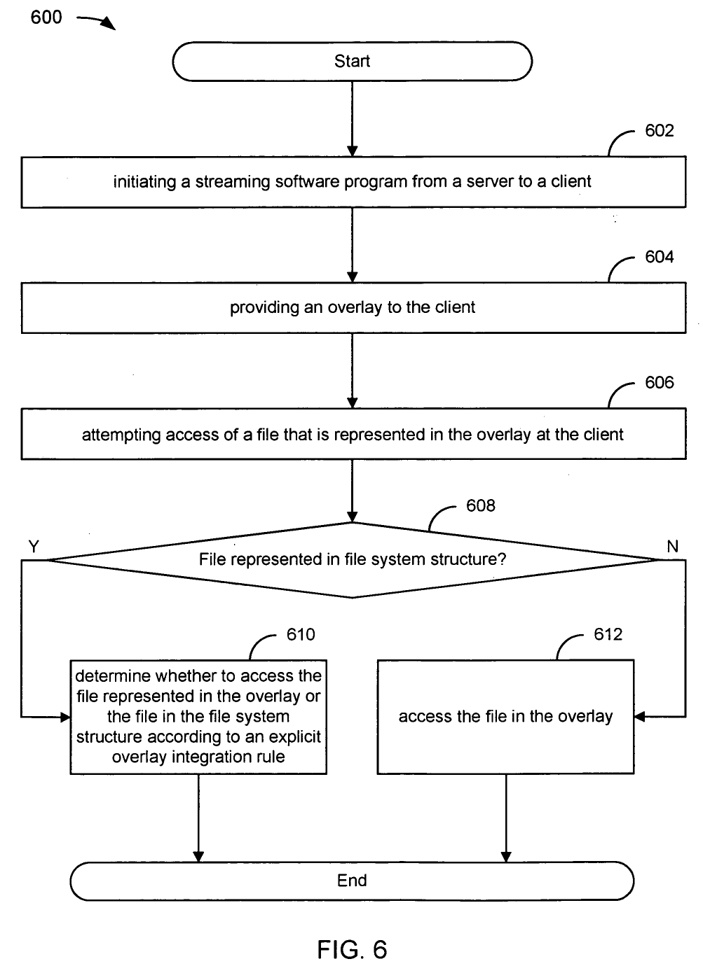

FIG. 6 depicts a flowchart 600 of an example of a method for using explicit overlay integration rules at a streaming client. The flowchart 600 begins at block 602 with initiating a streaming program from a streaming server to a client.

In the example of FIG. 6, the flowchart 600 continues at block 604 with providing an overlay to the client.

In the example of FIG. 6, the flowchart 600 continues at block 606 with attempting access of a file that is represented in the overlay at the client.

In the example of FIG. 6, the flowchart 600 continues at decision point 608 where it is determined whether the file is also represented in the file system structure of the client.

In the example of FIG. 6, if the file is also represented in the file system structure of the client (608-Y), then at block 610 it is determined whether to access the file represented in the overlay or the file in the file system structure according to an explicit overlay integration rule, and the flowchart 600 ends.

In the example of FIG. 6, if the file is not also represented in the file system structure of the client (608-N), then at block 612 the file is accessed in the overlay, and the flowchart 600 ends.

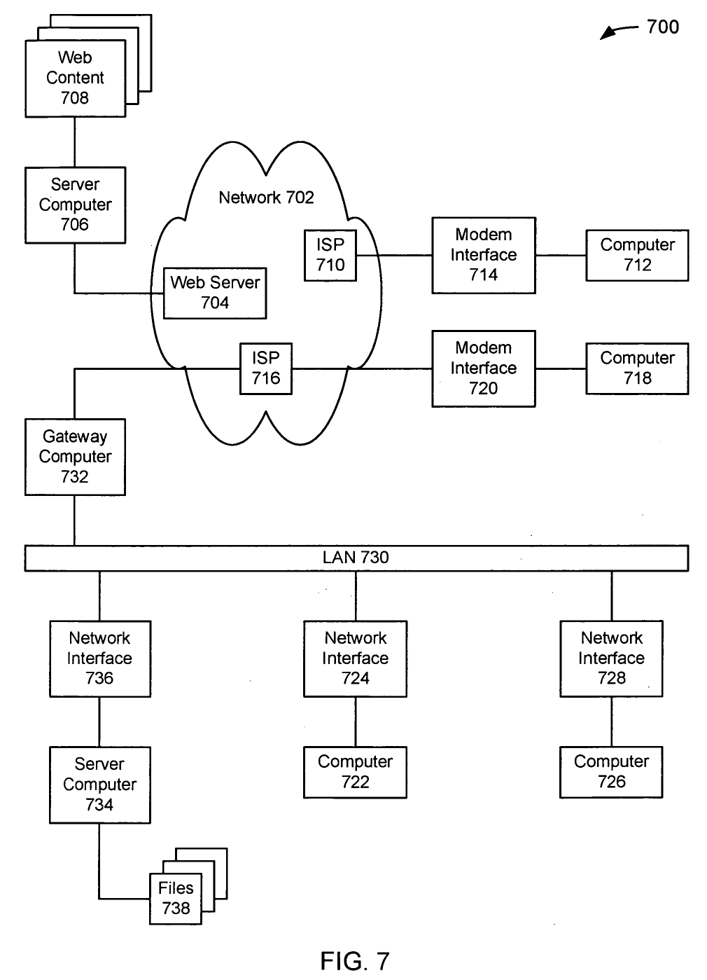

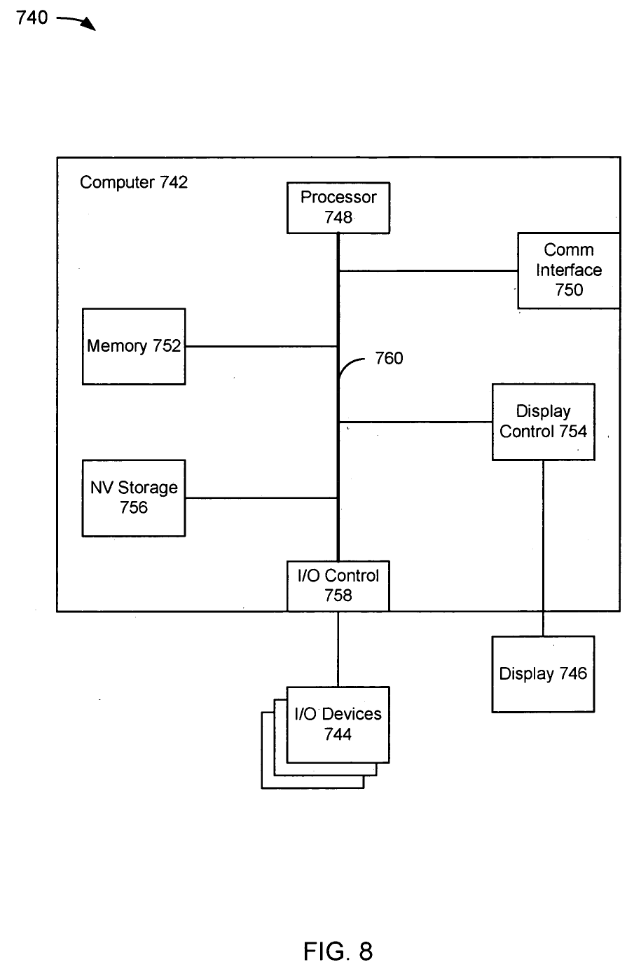

The following description of FIGS. 7 and 8 is intended to provide an overview of computer hardware and other operating components suitable for performing the methods of the invention described herein, but is not intended to limit the applicable environments. Similarly, the computer hardware and other operating components may be suitable as part of the apparatuses of the invention described herein. The invention can be practiced with other computer system configurations, including hand-held devices, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network.

FIG. 7 depicts a networked system 700 that includes several computer systems coupled together through a network 702, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (the web). The physical connections of the Internet and the protocols and communication procedures of the Internet are well known to those of skill in the art.

The web server 704 is typically at least one computer system which operates as a server computer system and is configured to operate with the protocols of the world wide web and is coupled to the Internet. The web server system 704 can be a conventional server computer system. Optionally, the web server 704 can be part of an ISP which provides access to the Internet for client systems. The web server 704 is shown coupled to the server computer system 706 which itself is coupled to web content 708, which can be considered a form of a media database. While two computer systems 704 and 706 are shown in FIG. 7, the web server system 704 and the server computer system 706 can be one computer system having different software components providing the web server functionality and the server functionality provided by the server computer system 706, which will be described further below.

Access to the network 702 is typically provided by Internet service providers (ISPs), such as the ISPs 710 and 716. Users on client systems, such as client computer systems 712, 718, 722, and 726 obtain access to the Internet through the ISPs 710 and 716. Access to the Internet allows users of the client computer systems to exchange information, receive and send e-mails, and view documents, such as documents which have been prepared in the HTML format. These documents are often provided by web servers, such as web server 704, which are referred to as being “on” the Internet. Often these web servers are provided by the ISPs, such as ISP 710, although a computer system can be set up and connected to the Internet without that system also being an ISP.

Client computer systems 712, 718, 722, and 726 can each, with the appropriate web browsing software, view HTML pages provided by the web server 704. The ISP 710 provides Internet connectivity to the client computer system 712 through the modem interface 714, which can be considered part of the client computer system 712. The client computer system can be a personal computer system, a network computer, a web TV system, or other computer system. While FIG. 7 shows the modem interface 714 generically as a “modem,” the interface can be an analog modem, isdn modem, cable modem, satellite transmission interface (e.g. “direct PC”), or other interface for coupling a computer system to other computer systems.

Similar to the ISP 714, the ISP 716 provides Internet connectivity for client systems 718, 722, and 726, although as shown in FIG. 7, the connections are not the same for these three computer systems. Client computer system 718 is coupled through a modem interface 720 while client computer systems 722 and 726 are part of a LAN 730.

Client computer systems 722 and 726 are coupled to the LAN 730 through network interfaces 724 and 728, which can be Ethernet network or other network interfaces. The LAN 730 is also coupled to a gateway computer system 732 which can provide firewall and other Internet-related services for the local area network. This gateway computer system 732 is coupled to the ISP 716 to provide Internet connectivity to the client computer systems 722 and 726. The gateway computer system 732 can be a conventional server computer system.

Alternatively, a server computer system 734 can be directly coupled to the LAN 730 through a network interface 736 to provide files 738 and other services to the clients 722 and 726, without the need to connect to the Internet through the gateway system 732.

FIG. 8 depicts a computer system 740 for use in the system 700 (FIG. 7). The computer system 740 may be a conventional computer system that can be used as a client computer system or a server computer system or as a web server system. Such a computer system can be used to perform many of the functions of an Internet service provider, such as ISP 710 (FIG. 7).

In the example of FIG. 8, the computer system 740 includes a computer 742, I/O devices 744, and a display device 746. The computer 742 includes a processor 748, a communications interface 750, memory 752, display controller 754, non-volatile storage 756, and I/O controller 758. The computer system 740 may be couple to or include the I/O devices 744 and display device 746.

The computer 742 interfaces to external systems through the communications interface 750, which may include a modem or network interface. It will be appreciated that the communications interface 750 can be considered to be part of the computer system 740 or a part of the computer 742. The communications interface can be an analog modem, isdn modem, cable modem, token ring interface, satellite transmission interface (e.g. “direct PC”), or other interfaces for coupling a computer system to other computer systems.

The processor 748 may be, for example, a conventional microprocessor such as an Intel Pentium microprocessor or Motorola power PC microprocessor. The memory 752 is coupled to the processor 748 by a bus 760. The memory 752 can be dynamic random access memory (DRAM) and can also include static ram (SRAM). The bus 760 couples the processor 748 to the memory 752, also to the non-volatile storage 756, to the display controller 754, and to the I/O controller 758.

The I/O devices 744 can include a keyboard, disk drives, printers, a scanner, and other input and output devices, including a mouse or other pointing device. The display controller 754 may control in the conventional manner a display on the display device 746, which can be, for example, a cathode ray tube (CRT) or liquid crystal display (LCD). The display controller 754 and the I/O controller 758 can be implemented with conventional well known technology.

The non-volatile storage 756 is often a magnetic hard disk, an optical disk, or another form of storage for large amounts of data. Some of this data is often written, by a direct memory access process, into memory 752 during execution of software in the computer 742. One of skill in the art will immediately recognize that the terms “machine-readable medium” or “computer-readable medium” includes any type of storage device that is accessible by the processor 748 and also encompasses a carrier wave that encodes a data signal.

Objects, methods, inline caches, cache states and other object-oriented components may be stored in the non-volatile storage 756, or written into memory 752 during execution of, for example, an object-oriented software program. In this way, the components illustrated in, for example, FIGS. 1-3 and 6 can be instantiated on the computer system 740.

The computer system 740 is one example of many possible computer systems which have different architectures. For example, personal computers based on an Intel microprocessor often have multiple buses, one of which can be an I/o bus for the peripherals and one that directly connects the processor 748 and the memory 752 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 752 for execution by the processor 748. A Web TV system, which is known in the art, is also considered to be a computer system according to the present invention, but it may lack some of the features shown in FIG. 8, such as certain input or output devices. A typical computer system will usually include at least a processor, memory, and a bus coupling the memory to the processor.

In addition, the computer system 740 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 756 and causes the processor 748 to execute the various acts required by the operating system to input and output data and to store data in memory, including storing files on the non-volatile storage 756.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention, in some embodiments, also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the present invention is not described with reference to any particular programming language, and various embodiments may thus be implemented using a variety of programming languages.

While this invention has been described in terms of certain embodiments, it will be appreciated by those skilled in the art that certain modifications, permutations and equivalents thereof are within the inventive scope of the present invention. It is therefore intended that the following appended claims include all such modifications, permutations and equivalents as fall within the true spirit and scope of the present invention; the invention is limited only by the claims.

What is claimed is:

1. A method, comprising:
providing an overlay to a file system structure;
providing an explicit overlay integration rule;
directing a file access for a file that resides in the file system structure and in the overlay to either the file system structure or the overlay depending upon the explicit overlay integration rule.

2. The method of claim 1, wherein the overlay is associated with a streaming software program.

3. The method of claim 1, wherein providing an overlay to the filesystem structure includes:
prompting a user to enter an explicit overlay integration rule;
receiving the explicit overlay integration rule from the user.

4. The method of claim 1, wherein the file in the overlay and the file in the filesystem structure have identical names, but different file details.

5. The method of claim 1, wherein the filesystem structure includes a filesystem directory.

6. The method of claim 1, wherein the filesystem structure includes filesystem files.

7. The method of claim 1, further comprising directing a file access for a file that resides in the filesystem structure to the filesystem structure.

8. The method of claim 1, further comprising directing a file access for a file that resides in the overlay to the overlay.

9. The method of claim 1, wherein the explicit overlay integration rule indicates that a file access for a file that resides in the filesystem structure and in the overlay is to be directed to the overlay.

10. The method of claim 1, wherein the explicit overlay integration rule indicates that a file access for a file that resides in the filesystem structure and in the overlay is to be directed to the filesystem structure.

11. The method of claim 1, wherein the explicit overlay integration rule indicates that a file access for a file that resides in the filesystem structure and in the overlay is to be directed to the filesystem structure or the overlay depending upon characteristics of directories in which the file resides.

12. The method of claim 1, wherein the explicit overlay integration rule indicates that a file access for a file that resides in the filesystem structure and in the overlay is to be directed to the filesystem structure or the overlay depending upon characteristics of the file.

13. A method, comprising:
receiving an access request for a file;
consulting explicit overlay integration rules;
accessing the file in an overlay if an explicit overlay integration rule indicates the overlay has precedence over a file system structure;
accessing the file in the file system structure if the explicit overlay integration rule indicates the file system structure has precedence over the overlay;
accessing the file according to file characteristics if the overlay integration rule indicates the overlay and the file system structure have equivalent precedence.

14. The method of claim 13, wherein the overlay is associated with a streaming software program.

15. The method of claim 13, wherein the file in the overlay and the file in the filesystem structure have identical names, but different file details.

16. The method of claim 13, further comprising providing the explicit overlay integration rule.

17. The method of claim 13, further comprising providing the overlay.

18. The method of claim 13, further comprising determining whether the file is represented in both the overlay and in the filesystem structure.

19. The method of claim 13, further comprising:
determining whether the file is represented only in the overlay or only in the filesystem structure;
accessing the file in the overlay if the file is represented only in the overlay;
accessing the file in the filesystem structure if the file is represented only in the filesystem structure.

20. A system, comprising:
a means for providing an overlay to a file system structure;
a means for providing an explicit overlay integration rule;
means for directing a file access for a file that resides in the file system structure and in the overlay to either the file system structure or the overlay depending upon the explicit overlay integration rule.
